(19) United States
(12) Patent Application Publication
(10) Pub. No.: US 2004/0214068 A1
(43) Pub. Date: Oct. 28, 2004

(54) Fuel cell and method for manufacturing the same

(76) Inventors: Shou-Shing Hsieh, Kaohsiung (TW); Jenn-Kun Kuo, Kaohsiung (TW); Ching-Feng Huang, Kaohsiung (TW); Huang-Hsiu Tsai, Kaohsiung (TW); Chih-Yi Lin, Kaohsiung (TW); Chi-Hsun Tien, Kaohsiung (TW); Sheng-Hoang Yang, Kaohsiung (TW)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/768,903

(22) Filed: Jan. 29, 2004

(30) Foreign Application Priority Data
Apr. 23, 2003 (TW) 092109473

(51) Int. Cl. H01M 8/02; H01M 8/10; H01M 4/86; B05D 5/12

(52) U.S. Cl. 429/38; 427/115; 429/30; 429/44

(57) ABSTRACT

The invention relates to a fuel cell and a method for manufacturing the same. The method of the invention comprises the steps of: (a) forming a catalyst layer on a first surface and a second surface of a membrane electrode assembly; (b) forming a plurality of channels on a first reaction surface of a first flow field plate and on a second reaction surface of a second flow field plate, with each channel having an inclined side wall; (c) forming a current collector layer on the first reaction surface and the second reaction surface; and (d) combining the first flow field plate on the first surface of the membrane electrode assembly, and combining the second flow field plate on the second surface of the membrane electrode assembly. The method of the invention utilizes the sputtering method to deposit the catalyst layer and the current collector layer so as to effectively control the thickness of the catalyst layer and the current collector layer. Therefore, the method of the invention allows the catalyst layer to develop its function and saves material. The current collector layer is able to be as thin as a membrane, which makes it easier for it to collect current. In addition, the flow field plate can be made by lithographic technology, which decreases the width of the channels and increases the storage of hydrogen per unit area. Consequently, the size of the fuel cell of the invention can be minimized.

### BACKGROUND OF THE INVENTION

1. Field of the Invention

The present invention relates to a fuel cell and a method for manufacturing the same, more particularly, to a micro fuel cell and a method for manufacturing the same.

2. Description of the Related Art

The conventional fuel cell refers to U.S. Pat. No. 6,339,400 B1, entitled “FUEL CELL SYSTEM,” ROC patent application under Publication No. 480762, entitled “MODULIZED SINGLE CELL AND ASSEMBLED CELL UNIT OF A PROTON EXCHANGE MEMBRANE FUEL CELL” and ROC patent application under Publication No. 507395, entitled “FUEL CELL.”

Referring to FIG. 1, a conventional fuel cell 10 comprises: a proton exchange layer 11, a first flow field plate 12, a second flow field plate 13, a first current collector plate 14, a second current collector plate 15, a first gasket 16, a second gasket 17, a first housing 18 and a second housing 19. The proton exchange layer 11 comprises a proton exchange membrane 111 and two catalyst layers 112 and 113. Usually, the proton exchange membrane 111 is Nafion 117 (ElectroChem, Inc), and the catalyst layers 112 and 113 are platinum (Pt). The thickness of the catalyst layers 112 and 113 can not be controlled well, and are not uniform on the surface. Besides, if the catalyst layer is too thin, it will affect the output power of the fuel cell, however, if the catalyst layer is too thick, it will waste the platinum material.

The first flow field plate 12 and the second flow field plate 13 respectively have channels 121 and 131 for the reaction gas. Because the first flow field plate 12 and the second flow field plate 13 are carbon, and the processing equipment for the channels is not improved, the channels can not be processed precisely, so that the effective anode area is small.

The first current collector plate 14 and the second current collector plate 15 are made of copper (Cu), and the first gasket 16 and the second gasket 17 are made of rubber. Therefore, the conventional fuel cell 10 needs many layers and has a large volume.

Therefore, it is necessary to provide an innovative and progressive fuel cell so as to solve the above problem.

### SUMMARY OF THE INVENTION

One objective of the present invention is to provide a method for manufacturing the same. The method of the invention comprises the steps of: (a) forming a catalyst layer on a first surface and a second surface of a membrane electrode assembly, respectively; (b) forming a plurality of channels on a first reaction surface of a first flow field plate and on a second reaction surface of a second flow field plate, with each channel having an inclined side wall; (c) forming a current collector layer on the first reaction surface and the second reaction surface, respectively; and (d) combining the first flow field plate on the first surface of the membrane electrode assembly, and combining the second flow field plate on the second surface of the membrane electrode assembly.

According to the method of the invention, the sputtering method is utilized to deposit the catalyst layer so as to effectively control the thickness of the catalyst layer. Therefore, the method of the invention makes the catalyst layer develop its function and saves the material of the catalyst layer. In addition, the channels of the flow field plate can be made by lithographic technology, which decreases the width of the channels and increases the storage of hydrogen per unit area. In addition, the sputtering method is utilized to deposit the current collector layer on the first reaction surface and the second reaction surface so as to effectively control the thickness of the current collector layer. The current collector layer is able to be as thin as a membrane, which makes it easier for it to collect current. Consequently, the size of the fuel cell of the invention can be minimized.

### BRIEF DESCRIPTION OF THE DRAWINGS

FIG. 1 is an exploded perspective view showing a conventional fuel cell.

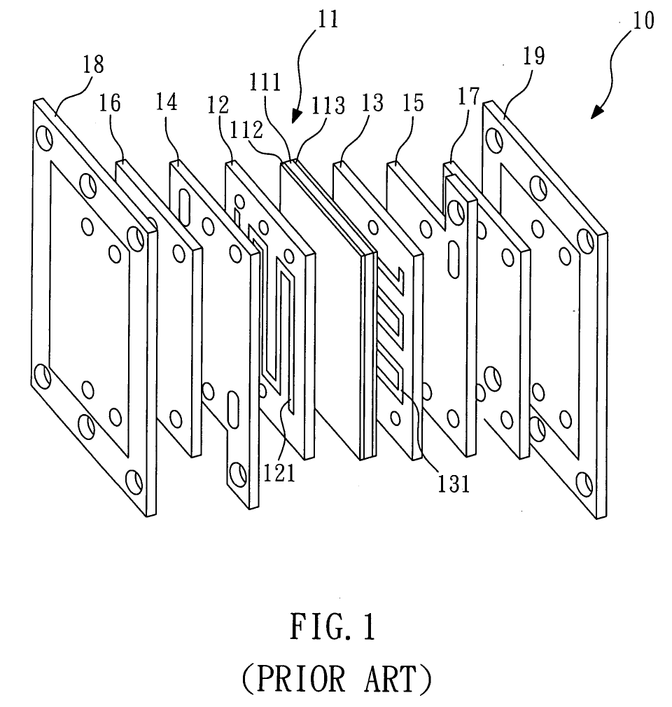

FIG. 2 is an exploded perspective view showing a fuel cell, according to the invention.

FIG. 3 is a top view showing the second flow field plate, according to the invention.

FIG. 4 shows an enlarged partial cross-sectional view of the second flow field plate, according to the invention.

### DETAILED DESCRIPTION OF THE INVENTION

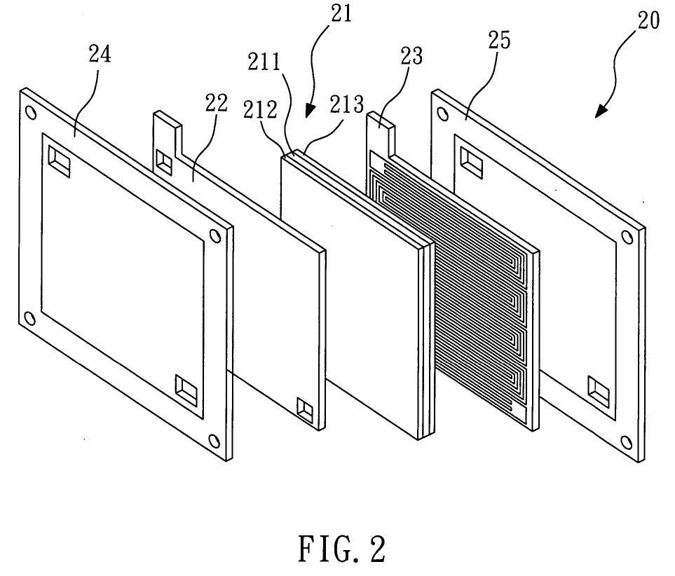

Referring to FIG. 2, according to the invention, a fuel cell 20 comprises: a proton exchange layer 21, a first flow field plate 22, a second flow field plate 23, a first housing 24 and a second housing 25. The proton exchange layer 21 comprises a membrane electrode assembly (MEA) 211 and two catalyst layers 212 and 213. The membrane electrode assembly 211 has a first surface and a second surface. Usually, the membrane electrode assembly 211 is Nafion 117 (ElectroChem, Inc), and the catalyst layers 112 and 113 are platinum (Pt). Two catalyst layers 212 and 213 are respectively formed on the first surface and the second surface of the membrane electrode assembly. The second surface corresponds to the first surface.

Two catalyst layers 212 and 213 are respectively deposited on the first surface and the second surface of the membrane electrode assembly 211 by the sputtering method so as to effectively control the thickness of the catalyst layer 212, 213. The thickness of the catalyst layers 212 and 213 are controlled between 25 nm and 80 nm. Therefore, the thickness of the catalyst layers 212 and 213 is thin, and the catalyst layers 212 and 213 can develop its function and the material of the catalyst layers 212 and 213 can be saved. Furthermore, the sputtering method for depositing the catalyst layers 212 and 213 of the invention is simpler than the conventional hot pressing method, and is able to effectively control the thickness of the catalyst layers 212 and 213.

The first flow field plate 22 has a first reaction surface facing the catalyst layer 212 and the first surface of the membrane electrode assembly 211. The second flow field plate 23 has a second reaction surface facing the catalyst layer 213 and the second surface of the membrane electrode assembly 211. The first flow field plate 22 and the second flow field plate 23 are preferably polymethylmetharylate (PMMA), and their thickness is preferably between 250 μm and 500 μm.

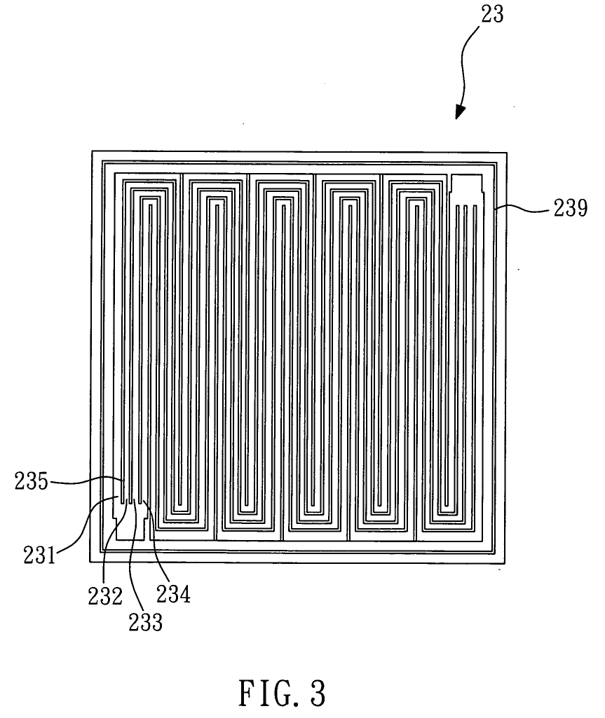

Referring to FIG. 3, FIG. 3 shows the second flow field plate 23. The second flow field plate 23 is taken as an example. The invention utilizes lithographic technology, for example an excimer laser bulk micromachining process, to form a plurality of channels 231, 232, 233 and 234 on the second reaction surface of the second flow field plate 23. The channels 231, 232, 233 and 234 are about 50 to 400 μm. A rib is spaced between two adjacent channels, for example there is a rib 235 spaced between channels 231 and 232 for parting the two adjacent channels. The width of the rib is between 10 μm and 50 μm. Therefore, the width of the channels of the first flow field plate 22 and the second flow field plate 23 can be controlled to be small so as to increase the storage of hydrogen per unit area.

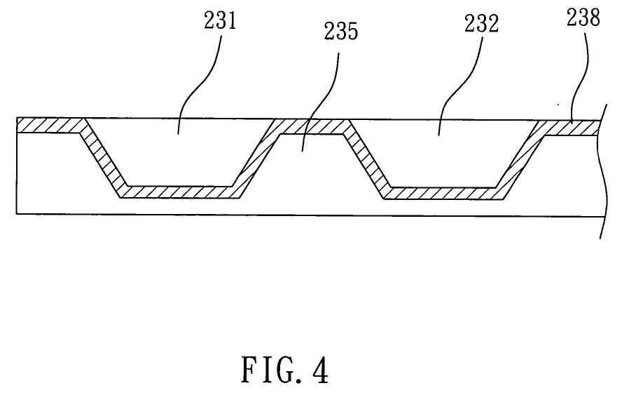

FIG. 4 shows an enlarged partial cross-sectional view of the second flow field plate 23. The channels 231, 232 have inclined side walls so that the sputtering method can be used to deposit a current collector layer 238 on the channels 231, 232 and the rib 235. That is, the current collector layer 238 is deposited on the second reaction surface of the second flow field plate 23 by the sputtering method. Therefore, according to the invention, the fuel cell of the invention does not need the conventional current collector plate as the conventional fuel cell, and the space of the conventional current collector plate can be saved to minimize the size of the fuel cell of the invention.

Furthermore, The current collector layer 238 is able to be as thin as a membrane, which makes it easier for it to collect current. The current collector layer 238 preferably is selected from a group consisting of copper (Cu), silver (Ag) or gold (Au), and the thickness of the current collector layer 238 is about 0.1 to 1 μm.

The first reaction surface of the first flow field plate 22 is combined on the catalyst layer 212 and the first surface of the membrane electrode assembly 211. The second reaction surface of the second flow field plate 23 is combined on the catalyst layer 213 and the second surface of the membrane electrode assembly 211. Referring to FIG. 3 again, the second flow field plate 23 is taken as an example. There is glue 239 painted on the edge of the second reaction surface of the second flow field plate 23 so as to combine the catalyst layer 213 and the second surface of the membrane electrode assembly.

According to the manufacturing method and the configuration of the fuel cell of the invention, the thickness of each layer can be controlled effectively, and can be decreased to minimize the total size of the fuel cell. In addition, the fuel cell of the invention can achieve a power density of 25 mW/cm² at 0.6 Voltage.

While an embodiment of the present invention has been illustrated and described, various modifications and improvements can be made by those skilled in the art. The embodiment of the present invention is therefore described in an illustrative, but not restrictive, sense. It is intended that the present invention may not be limited to the particular forms as illustrated, and that all modifications which maintain the spirit and scope of the present invention are within the scope as defined in the appended claims. What is claimed is:

1. A method for manufacturing a fuel cell, comprising the steps of:
(a) forming a catalyst layer on a first surface and a second surface of a membrane electrode assembly respectively;
(b) forming a plurality of channels on a first reaction surface of a first flow field plate and on a second reaction surface of a second flow field plate, with each channel having an inclined side wall;
(c) forming a current collector layer on the first reaction surface and the second reaction surface respectively; and
(d) combining the first flow field plate on the first surface of the membrane electrode assembly, and combining the second flow field plate on the second surface of the membrane electrode assembly.

2. The method according to claim 1, wherein in step (a), the catalyst layer is formed by a sputtering method.

3. The method according to claim 1, wherein in step (a), the catalyst layer is platinum, and the thickness of the catalyst is 25 to 80 nm.

4. The method according to claim 1, wherein in step (b), the channels are formed by lithographic technology.

5. The method according to claim 1, wherein in step (b), the first flow field plate and the second flow field plate are polymethylmetharylate (PMMA).

6. The method according to claim 1, wherein in step (b), a rib is formed between two channels, and used for spacing two channels.

7. The method according to claim 1, wherein in the (c), the current collector layer is formed by the sputtering method.

8. The method according to claim 1, wherein in step (c), the current collector layer is selected from a group consisting of copper, silver and gold.

9. The method according to claim 1, wherein in step (d), glue is painted on the edge of the first reaction surface and the second reaction surface so as to combine the membrane electrode assembly.

10. A fuel cell, comprising:
a membrane electrode assembly, having a first surface and a second surface, a catalyst layer formed on the first surface and the second surface, respectively;
a first flow field plate, having a first reaction surface, a plurality of channels and a first current collector layer, the channels formed on the first reaction surface, each channel having an inclined side wall, the first current collector layer formed on the first reaction surface, the first reaction surface of the first flow field plate combined on the first surface of the membrane electrode assembly; and
a second flow field plate, having a second reaction surface, a plurality of channels and a second current collector layer, the channels formed on the second reaction surface, each channel having an inclined side wall, the second current collector layer formed on the second reaction surface, the second reaction surface of the second flow field plate combined on the second surface of the membrane electrode assembly.

11. The fuel cell according to claim 10, wherein the catalyst layer is platinum, and the thickness of the catalyst is 25 to 80 nm.

12. The fuel cell according to claim 10, wherein the first flow field plate and the second flow field plate are polymethylmetharylate (PMMA).

13. The fuel cell according to claim 10, wherein the first flow field plate and the second flow field plate further comprises a plurality of ribs formed between two channels, and the ribs are used for spacing the two channels.

14. The fuel cell according to claim 10, wherein the current collector layer is selected from a group consisting of copper, silver and gold.
